(19) United States
(12) Patent Application Publication
(10) Pub. No.: US 2006/0107205 A1
(43) Pub. Date: May 18, 2006

(54) Determining a main content area of a page

(75) Inventor: Mikko Makela, Tampere (FI)

Correspondence Address: WARE FRESSOLA VAN DER SLUYS &;ADOLPHSON, LLP, BRADFORD GREEN BUILDING 5, 755 MAIN STREET, P O BOX 224, MONROE, CT, 06468, US

(73) Assignee: Nokia Corporation

(21) Appl. No.: 10/988,425

(22) Filed: Nov. 12, 2004

(51) Int. Cl. G06F 17/21

(52) U.S. Cl. 715/520; 715/517; 715/513

(57) ABSTRACT

A method, a computer program, a computer program product, a device and a system for determining a main content area of a page, determines which area of the page contains a page element that is positioned substantially in the middle of the page with respect to a first direction, and is offset by a pre-defined distance from a border of the page with respect to a second direction that is orthogonal to the first direction, and wherein the area that contains the page element is defined to be the main content area.

### FIELD OF THE INVENTION

This invention relates to a method, a computer program, a computer program product, a device and a system for determining a main content area of a page.

### BACKGROUND OF THE INVENTION

The ongoing miniaturization of multi-media devices such as Personal Digital Assistants (PDAs) or mobile phones in recent years appears to be only bounded by the perceptual limits of the human user. This particularly applies to the design of the displays of multimedia devices, with a remarkable trend to increase the relative area of the device that is consumed by its display. However, the display sizes of, for example, hand-held devices are necessarily significantly smaller than the display sizes, for which content is usually designed. If for instance content of the World Wide Web (WWW), i.e. web pages formatted according to the Hypertext Markup Language (HTML) or derivatives thereof (such as Extensible HTML (XHTML)), is to be displayed on the display of a hand-held device, it has to be considered that these web pages normally have an original presentation size designed for portrayal on a computer monitor, the dimensions of which are often remarkably larger than the display dimensions of a hand-held device such as a mobile phone.

State-of-the-art browsers that are installed in, for example, hand-held devices and provide for the interpretation of the web page content offer the following techniques to view large web pages on small displays:

a) Original Layout Mode

This approach represents the most straightforward technique. The web page is displayed in its original layout, for instance with 100% zoom factor. Objects of said web page then have the size (in pixels or inches) that is prescribed by the object format (e.g. image or text format) and/or the markup language. For instance, if an image in the web page is defined to have a size of 40×40 pixels, it will also be displayed by 40×40 pixels of the display of the hand-held device, even if the hand-held device only has a display area of 176×208 pixels at all. In this original layout mode, as the web page area is big, and as only a fraction of the web page area fits into the small display, a lot of panning and zooming is needed to explore the entire content of the web page. Furthermore, on a small display, it is difficult to figure out the structure of a large page, i.e. the viewer may lose an overview of the entire web page. Finally, text paragraphs in the original layout usually are wider than the display width, so that paragraphs in the original layout mode on a small display are often difficult to read.

b) Rendering Pages

According to this approach, the web page is rendered (re-formatted) so that it fits the width of the device's display. The entire web page then is stacked into a single column that has a width equal to or smaller than the width of the display, and the contents of which can be explored by vertical scrolling. With increasing size of a web page, this column may get very tall, and a lot of scrolling may be required to view all contents of the web page.

c) Small Representation and Selective Enlargement of Areas of the Web Page

According to this approach, a web page is first divided into a plurality of areas, and this plurality of areas is then displayed in small representation. In this small representation, the areas are scaled to a size that is smaller than their corresponding size in original layout mode, so that all areas can be jointly displayed on the display of the hand-held device. Some of said areas, for instance areas with sufficient amount of content, are made selectable, and upon selection of one of said areas by user interaction, for instance by moving an accentuation frame among said selectable areas by a cursor and pressing a selection button, at least said selected area is displayed in a large representation, which is significantly larger than the small representation. During said displaying of said selected area in said large representation, adjacent areas may be at least partially displayed in small or large representation. This approach thus allows a user to switch between said small representation, in which an overview on the structure of the web page is easily preserved, or a large representation, in which content of selected areas can be explored in more detail.

The common problem in all of the above-mentioned approaches to display large web pages on a small display is that a web page usually contains its main content in the center of the page, but that in said three approaches, when a new web page is loaded and initially displayed on the display, the focus is by default set to the top (approach b)) or to the top left corner (approach a) and c)).

This problem is illustrated in FIG. 1 and FIGS. 2a-2c. In FIG. 1, an exemplary web page 1 of an internet search engine is depicted in its original layout with 100% zoom factor, as it would for instance be displayed on a computer monitor. It comprises advertisement banners 10, 11 and 12, a page title 13, and a field 14 that is composed of a text entry field 140 and a search button 141. By entering search strings into the text entry field 140 and clicking the search button 141, a user can perform a search operation in the internet. The field 14 can be considered as the main content area of the entire web page 1, and it would be desirable for a user to have direct access to this main content area 14 even when viewing the web page 1 on a small display of a hand-held device.

FIGS. 2a-2c illustrate the displaying of different representations 2a, 2b and 2c of said web page 1 on a small display of a hand-held device, respectively. The representations 2a, 2b and 2c correspond to the above-listed three approaches a), b) and c) of how to display a large web page on a small display, respectively.

In FIG. 2a, said representation 2a is an original layout representation of said web page 1 (approach a)), wherein by default, only the left upper portion of web page 1 is visible in the small display. Accordingly, only parts of the banner 10 and of the page title 13 are visible, and horizontal and vertical scroll bars 21 and 20 are provided to allow for an exploration of the remaining content of web page 1. As can be seen by comparing FIG. 2a and FIG. 1, a lot of both vertical and horizontal scrolling is required in this representation 2a to reach the main content area 14.

In FIG. 2b, said representation 2b is a representation wherein said web page 1 has been rendered to fit the width of the small display (approach b)). Thus all elements 10-14 of of web page 1 have been stacked in one tall column on top of each other, and only banner 10 is visible on the small display. To allow for vertical scrolling, a vertical scroll bar 20 is provided. Similar to representation 2a, also in representation 2b, a lot of vertical scrolling is required reach the main content area 14.

In FIG. 2c, said representation 2c is a representation in which said web page 1 has been divided into a plurality of areas 10′-14′, which are displayed in small representation on the small display (approach c)). Upon selection of one of said areas 10′-14′, at least said selected area then is displayed enlarged. To allow for this selection, an accentuation frame 23 is provided, which by default focuses the left topmost area 10′. To select the main content area 14′, the accentuation frame 23 has to be moved via area 13′ to area 14′, again requiring user interaction.

Summing up, in order to view the main content area 14 in the center of the web page 1 on a small display, the user has to perform a lot of vertical and horizontal scrolling in approach a), has to perform a lot of vertical scrolling in approach b), and has to move said accentuation frame from the top left selectable area to the selectable area that contains the main content in approach c). Consequently, in all three approaches for displaying large web pages on a small display, a lot of user interaction is required until the user can view the main content of said web page.

To reduce this amount of user interaction, it has been proposed in the context of approach b) (e.g. in the WebViewer browser from ReqWireless) to determine a main content area of a web page, and to provide a selectable link to said main content area. This link 22 is exemplarily depicted in FIG. 2b. Upon selection of said link 22 by a user, the browser automatically scrolls to the main content area. Therein, the determination of said main content area is based on the assumption of a strict column structure of the web page and fails if this column structure is not obeyed by the web page.

### SUMMARY OF THE INVENTION

In view of the above-mentioned problems, a method, a computer program, a computer program product, a device and a system are proposed that allow for an improved determination of a main content area of a page.

It is proposed a method for determining a main content area of a page, said method comprising determining which area of said page contains a page element that is positioned substantially in the middle of said page with respect to a first direction, and is offset by a pre-defined distance from a border of said page with respect to a second direction that is substantially orthogonal to said first direction, and defining said area that contains said page element to be said main content area.

Said page may contain all types of information, it may for instance be a web page according to an HTML or XHTML standard, a text document, a slide of a presentation, an image, a video, or any other information-carrying entity. Said page may contain content of different type and/or relevance, and in particular a main content can be identified that may differ from the remaining content of said page. Said main content may be composed of several types of content, for instance text and images, and is assumed to be contained in a main content area of said page.

For said page, which is understood to be considered in its original layout (for instance, with 100% zoom factor) as prescribed by the format of the page, for instance an HTML or XHTML format in case of a web page, it is determined which area of said page contains a page element, and this area is then defined to be said main content area. Said determination may be based on a plurality of areas said page has been divided into before, for instance by means of a sectioning algorithm.

Said page element is positioned substantially in the middle of said page with respect to a first direction, for instance a horizontal direction, and is offset by a pre-defined distance from a border of said page with respect to a second direction, for instance a vertical direction. Therein, said positioning of said page element substantially in the middle of said page with respect to said first direction is to be understood to comprise a margin around said exact middle position. For instance, if said first direction is a horizontal direction, also positions at 40% of the width of the page taken from the right or left edge of a page shall be understood as substantially in the middle of said page. Shifting said position of said page element to the left from the exact center position may be advantageous for pages wherein the main writing direction is left-to-right, and shifting said position of said page element to the right from the exact center position may be advantageous for pages wherein the main writing direction is right-to-left (for instance pages in Hebrew or Arabic language). This slight deviation of said position of said page element from the exact center of said page with respect to said first direction may also produce a better result on pages that have more than three columns. For instance, if the main content of such a page is divided into two columns, this method may find the first of them.

Said page element is thus located in said page at a position that is defined by the center of said page with respect to said first direction (and a limited margin around said center as explained above), said pre-defined distance with respect to said second direction, and said first and second directions. Depending on the orientation of said first and second directions, which are substantially orthogonal to each other, and may for instance be horizontal and vertical directions (or also a depth direction (z-axis) in the context of 3D pages such as pages defined by the Virtual Reality Markup Language (VRML)), or vice versa, the position of said page element thus is either substantially in the center of the width of said page, and offset by said pre-defined distance with respect to the vertical direction, or substantially in the center of the height of said page, and offset by said pre-defined distance with respect to the horizontal direction.

Said page element may for instance be a pixel or a pixel position in said page.

Said second distance is pre-defined, but may be different for different types of pages or for pages with different characteristics, for instance for web pages with different dimensions or resolutions. Said second distance may also be adjusted by a user of a device in which said determination of said main content area is performed.

Thus according to the present invention, a main content area of a page is defined to be an area that contains a page element that is located at a pre-defined position in said page. The main content area of a page is thus assumed to be bound to a fixed location in said page. Said position may be adapted to different types of pages by altering the pre-defined distance and/or the orientation of said first and second direction, for instance, a substantially horizontally centered position may be considered as a location where main content of web pages is usually located.

In contrast to the prior art, wherein a main content area is determined based on the structure of a page, the present invention allows to determine a main content area of a page without requiring extensive and possibly erroneous analysis of the structure of the page.

The choice of a horizontally substantially centered position for the page element may be particularly advantageous if said page is a web page, for most web page designers try to avoid the need for horizontal scrolling of web pages by formatting content in a tall structure, which fits a width of a standard computer monitor or is even smaller than said width. Content then can be comfortably explored by using only a vertical scroll bar, which can for instance be operated by a scroll wheel that is provided by most of the state-of-the-art computer mice. Furthermore, to immediately furnish the user with the most interesting content upon entrance to the web page, i.e. before any vertical scrolling has been performed, the main content of the page is usually presented in an upper portion of said web page. Consequently, according to the present invention, determining a page element that is horizontally substantially centered in said representation of said page and only vertically offset by a pre-defined distance, which may for instance correspond to half of the height of a display of a computer monitor, then represents an approach that has a high probability of determining the correct main content area of said page.

According to an embodiment of the present invention, said first direction is a horizontal direction, said second direction is a vertical direction, and said pre-defined distance is taken from a top border of said page. Therein, said horizontal direction is understood to denote the direction from the left border of said page to the right border, and the vertical direction is understood to denote the direction from the top border of said page to the bottom border. This choice for the position of said page element is particularly advantageous if said page is a web page, where content is usually horizontally centered to avoid the need for horizontal scrolling, and then a suited choice for said pre-defined distance may for instance be 300 pixels.

According to a further embodiment of the present invention, said page element is a pixel, and said pre-defined distance is measured in pixels. Said page element may also represent a pixel position only. Alternatively, said page element may also represent a structural element of said page, as for instance a table cell, if said page is formatted as a table.

According to a further embodiment of the present invention, said pre-defined distance is measured in percent with respect to a dimension of said page in said second direction.

Said pre-defined distance then is independent of any absolute sizes or dimensions of said page.

According to a further embodiment of the present invention, said step of determining which area of said page contains a page element comprises dividing said page into a plurality of areas by means of a sectioning algorithm. Said sectioning algorithm may for instance attempt to create areas of fixed sizes or to create areas that do not cut content. Said page then may be first divided into said plurality of areas, and it then may be determined which of said areas contains said page element.

According to a further embodiment of the present invention, a representation of said page is displayed. Said representation may for instance be a scaled or non-scaled representation of said page (with respect to its size in original layout), or a representation wherein said page is rendered to fit a width of a display, or a representation where said page is first divided into a plurality of areas, which are displayed in small representation, and wherein, upon selection of one of said areas, at least said selected area is displayed in large representation.

According to a further embodiment of the present invention, in said displayed representation of said page, a representation of said main content area is automatically focused. In this context, focusing may be understood as moving a viewers attention to said representation of said main content area.

According to a further embodiment of the present invention, said representation of said main content area is focused by moving said representation of said main content area to a center of a display. This is particularly advantageous if said representation of said page is an original layout representation of said page, which exceeds the dimensions of a display on which it is displayed.

According to a further embodiment of the present invention, said representation of said main content area is focused by aligning at least one border of said representation of said main content area with at least one border of a display, respectively. For instance, an upper left or right edge (defined by two borders, respectively) of said representation of said main content area may be aligned to the upper left or right edge of said display, respectively. Alternatively, a left or right border of said representation of said main content area may be aligned to a left or right border of said display, respectively.

According to a further embodiment of the present invention, in said displayed representation of said page, a representation of said main content area is automatically emphasized. Said emphasizing may for instance be accomplished by displaying an accentuation frame around said representation of said main content area.

According to a further embodiment of the present invention, said representation of said main content area is emphasized by displaying it in an enlarged representation. Therein, representations of adjacent areas of said main content area, or representations of all or at least some areas of the page may either be shown enlarged as well or not. This may for instance be advantageous if, there exists a user-selectable option of either automatically enlarging said representation of said main content area or not.

According to a further embodiment of the present invention, when displaying said representation of said page, a reference is provided to a representation of said main content area. Said reference may for instance be a link that is displayed together with said representation of said display, or a menu item that can be selected by a user by browsing a menu, or a key shortcut, or any other reference. By selecting said reference, a user then may trigger the focusing or emphasizing of said representation of said main content area.

According to a further embodiment of the present invention, said displayed representation of said page is a substantially original layout representation of said page. Said substantially original layout representation may for instance be a representation in which said page is displayed in its original layout (for instance with 100% zoom factor, so that, if sizes in said page are defined in pixels, an image in said page with a defined pixel size of N×M pixels is displayed by N×M pixels of said display), resulting in dimensions of the representation of the page that may be significantly larger than the dimensions of a display on which said representation of said page is to be displayed. However, a representation mode wherein some minor optimizations, like wrapping text lines to the display width or using a zoom factor that differs from 100%, while still maintaining the basic layout, is still to be understood as substantially original layout representation.

Therein, it should be noted that in the future, the zoom factor of a page in substantially original layout representation may substantially differ from a 100% zoom factor, because sizes of items on web pages are often defined in pixels (images, for instance), and pixel size of phone displays is getting extremely small with increasing resolutions. This may lead to a situation where a substantially original layout representation has to use a zoom factor of 200% or even more in order to appropriately display said original layout of said page, and said original layout representation then may also be understood as a representation where content of said page is displayed on said display with approximately the same size (measured in inches or similar units) as it would have when being displayed on a monitor that has a standard pixel size.

According to a further embodiment of the present invention, said displayed representation of said page is a representation in which said page is rendered to at least partially fit at least one dimension of a display. Said page may for instance be rendered to fit the width of a display, so that a tall structure is obtained that can be explored by vertical scrolling.

According to a further embodiment of the present invention, said displayed representation of said page is a representation in which a plurality of areas, into which said page has been divided, is displayed in a small representation, and in which upon selection of one of said areas displayed in small representation, at least said selected area is displayed in a large representation. Therein, said large representation of said selected area may also be shown separately, for instance in a different window on said display. Said dividing of said page into a plurality of areas may for instance be performed by a sectioning algorithm.

According to a further embodiment of the present invention, said representation of said page is displayed on a display of a hand-held multi-media device. Said device may for instance be a mobile phone, a personal digital assistant, a lap-top computer or any other portable device.

It is further proposed a computer program with instructions operable to cause a processor to perform the above-mentioned method steps. Said computer program may for instance be executed by the central processor of a hand-held device.

It is further proposed a computer program product comprising a computer program with instructions operable to cause a processor to perform the above-mentioned method steps. Said computer program product may for instance be any digital memory, like a random access memory, a cache or a read-only memory, or any removable digital storage medium like a memory stick, a memory card, a disc or an optical data carrier like a CD or DVD.

It is further proposed a device for determining a main content area of a page, comprising means arranged for determining which area of said page contains a page element that is positioned substantially in the middle of said page with respect to a first direction, and is offset by a pre-defined distance from a border of said page with respect to a second direction that is orthogonal to said first direction, and means arranged for defining said area that contains said page element to be said main content area.

Said device may for instance be a part of a client in a network, for instance a mobile phone in a mobile radio communications network, or a terminal in a wireless or wire-based Local Area Network (LAN) or the Internet. Equally well, said device may be a part of a network element of such a network, and may provide for the determining of main content areas of pages that are to be displayed on said client.

It is further proposed a system for determining a main content area of a page, comprising means arranged for determining which area of said page contains a page element that is positioned substantially in the middle of said page with respect to a first direction, and is offset by a pre-defined distance from a border of said page with respect to a second direction that is orthogonal to said first direction, and means arranged for defining said area that contains said page element to be said main content area.

The means of said system may be distributed onto at least one client and at least one network element in a network, as for instance a mobile radio communications network, or a terminal in a wireless or wire-based Local Area Network (LAN) or the Internet.

These and other aspects of the invention will be apparent from and elucidated with reference to the embodiments described hereinafter.

### BRIEF DESCRIPTION OF THE FIGURES

In the figures show:

FIG. 1: An exemplary web page in original layout according to the prior art;

FIG. 2a: an original layout representation of the web page of FIG. 1 on a small display according to the prior art;

FIG. 2b: a rendered representation of the web page of FIG. 1 on a small display according to the prior art;

FIG. 2c: a small representation of the web page of FIG. 1 on a small display according to the prior art;

FIG. 3: a network comprising a device for determining main content in a page according to an embodiment of the present invention;

FIG. 4: a flowchart of a method for determining a main content area in a page according to an embodiment of the present invention;

FIG. 5: a flowchart of an algorithm for dividing a page into a plurality of areas according to an embodiment of the present invention;

FIG. 6a: an original layout representation of the web page of FIG. 1 on a small display according to an embodiment of the present invention;

FIG. 6b: a rendered representation of the web page of FIG. 1 on a small display according to an embodiment of the present invention; and

FIG. 6c: a small representation of the web page of FIG. 1 on a small display according to an embodiment of the present invention.

### DETAILED DESCRIPTION OF THE INVENTION

The present invention proposes a new method for determining a main content area of a page, which method is not based on the structure or format of a page, and simply determines which area of said page contains a page element that is substantially centered in said page with respect to one direction and offset by a pre-defined distance from a border of said page with respect to an orthogonal direction to be a main content area. This concept is suited to determine main content areas for a variety of different page types and shall by no means be limited to the deployment in the context of web pages only, which will be considered in this detailed description of the invention.

Furthermore, it should be noted that the description in the introductory part of this specification may be used to support this detailed description of the invention.

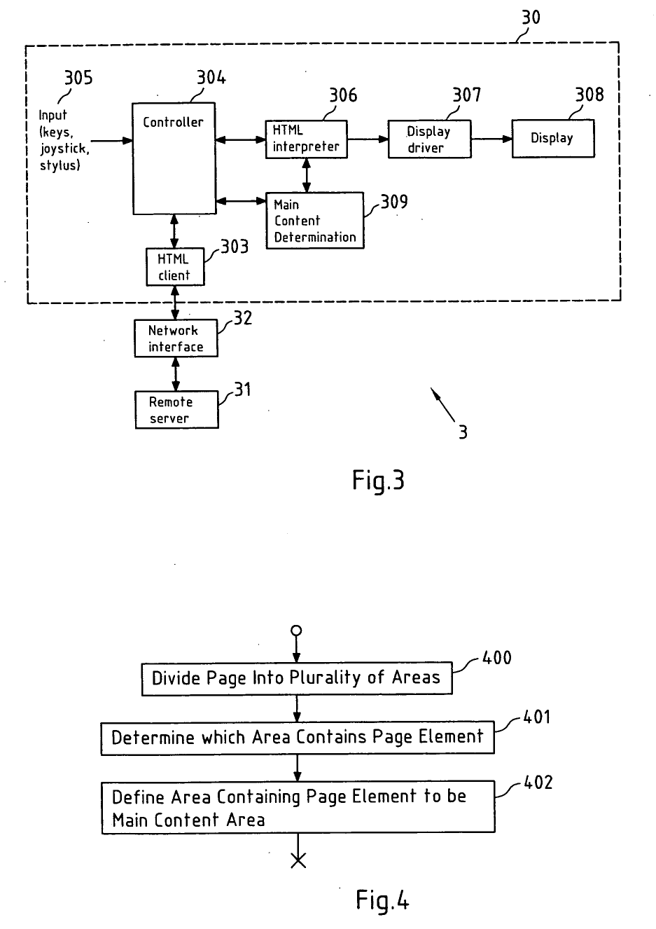

FIG. 3 depicts a network 3 comprising a terminal 30, a remote server 31, and a network interface 32. Pages that are stored on said remote server 31 can be transferred via said network interface 32 and then processed/displayed by said terminal 30. Therein, either said terminal 30 and/or said network interface 32 may comprise a device for determining main content in a page according to an embodiment of the present invention.

The terminal 30, for instance a hand-held multi-media device such as a mobile phone, comprises the standard components required to implement a browser functionality: The controller 304 controls the function of the browser and receives input 305 from a user for example via the keyboard, touch-screen, mouse interaction, or voice commands, e.g. the address of a new HTML/XHTML page that is to be loaded. The HTML client 303 provides services to the controller 304, in particular fetching of new HTML pages via the network interface 32, which is connected to remote server 31. If the terminal 30 is a hand-held multi-media device, said connection will usually be a wireless connection. The HTML interpreter 306 is responsible for the display of HTML pages on the display 308, which is controlled by the HTML interpreter 306 via a display driver 307. The HTML interpreter 306 parses the HTML source code of the HTML page and provides the display driver 307 with the corresponding results. In the prior art, in particular displaying said HTML page in different representations, such as for instance an original layout representation (approach a)), a rendered representation (approach b)) or a small representation with selectable areas (approach c)) is performed by the HTML interpreter 306 and display driver 307.

As an additional component, according to the present invention, said terminal 30 comprises a main content determination instance 302, which interacts with said HTML interpreter 306. Said main content determination instance 302 receives HTML pages and determines a main content area in said HTML pages, which is then signaled to the HTML interpreter 306, to trigger a focusing and/or accentuation of this main content area when the HTML pages are displayed on the display 308.

Said main content determination instance 302 may for instance comprise functionality to divide an HTML page into a plurality of areas, to determine which of said areas contains a pixel that is substantially horizontally centered in an original layout of this HTML object and vertically offset by a pre-defined distance (e.g. 300 pixels). Said area is then considered to contain the main content of said HTML page, and information on this main content area is signaled to the HTML interpreter. When processing said HTML page to be displayed on said display 308, said HTML interpreter 306 then may cause an automatic scrolling of the HTML page to this signaled main content area, may provide a link to this main content area (or may associate a menu item or keyboard shortcut with an automatic scrolling to said main content area), or may otherwise emphasize or accentuate this main content area.

Instead of providing functionality to divide said HTML page into a plurality of areas, said main content determination instance 302 may equally well use functionality to divide HTML pages into areas that may be provided by said HTML interpreter 306, in particular if said HTML pages are displayed in a way that an HTML page is first divided into a plurality of areas, which are displayed in a small representation, and then can be selected to cause an enlarged representation of the selected areas (approach c)).

It should be noted that the functionality that is provided by the main content determination instance 302 can also be provided by the network interface 32, which could analyze HTML pages during their transfer from the remote server 31 to the terminal 30 and signal information on main content areas in said HTML pages to said HTML interpreter 306 via the HTML client 303 and the controller 304. The main content determination instance 302 in the terminal 30 then may be obsolete, and processing power of the terminal 30 could be saved.

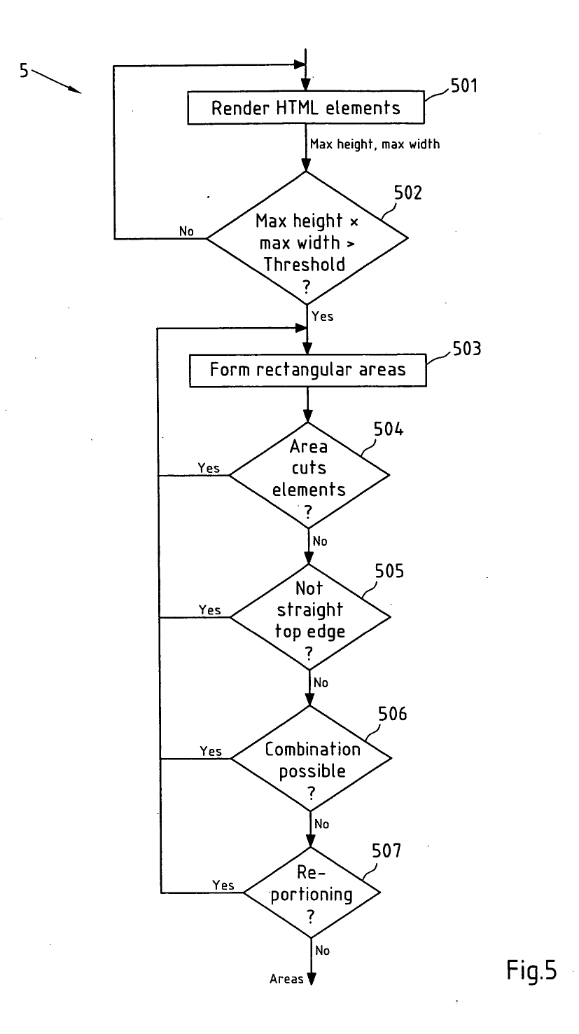

FIG. 4 depicts a flowchart of a method for determining a main content area in a page according to an embodiment of the present invention. The steps of this flowchart may for instance be performed by the main content determination instance 302 and the HTML interpreter 306 of FIG. 3.

In a first step 400, a page, in this exemplary case a web page, is divided into a plurality of areas, for instance by the algorithm that will be explained with reference to FIG. 5 below. In a step 401, it is then determined which of said areas contains a page element, in this exemplary case a pixel, that has a pre-defined position within said page. In the exemplary case that the page is a web page, it is particularly advantageous to define said page element to be located in a substantially horizontally centered position of the page, as web pages, at least in their original layout, are designed to avoid horizontal scrolling to the greatest possible extent, and thus main content is usually located in the center of the web page. Setting our from the observation that main content on web pages is also usually vertically centered with respect to a height of a display (not with respect to the height of the web page) on which the web page in its original layout format is displayed, for instance a computer monitor, so that, when a new page is displayed top-aligned on said display, the main content is instantly visible in the center of the display, it is most advisable to demand that said page element is offset from the top border of the web page by a certain distance, for instance 300 pixels.

Finally, said area out of said plurality of areas that contains this page element is then defined to be said desired main content area of said page in a step 402.

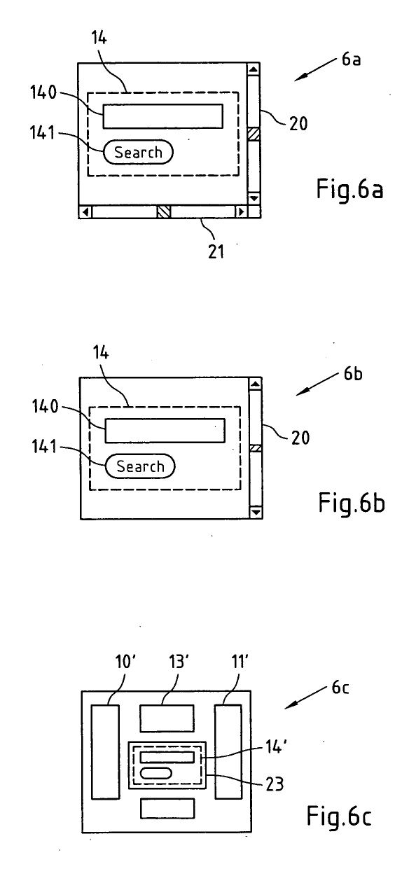

The result of this method for determining a main content area in a page, i.e. the determined main content area, then can be exploited to avoid unnecessary user interaction by triggering that a page is automatically scrolled to this main content area, or that a link to said main content area is provided, or that any other accentuation of focusing of this main content area is performed, as will be explained with reference to FIGS. 6a-6c below.

FIG. 5 depicts a simplified exemplary flowchart of an algorithm for dividing one or several pages, in this example HTML pages, into a plurality of areas according to the present invention. This algorithm may for instance be executed in step 400 of the flowchart of FIG. 4.

In step 501 of the flowchart of FIG. 5, HTML elements of one or several HTML pages are rendered and investigated in the order they appear in the HTML source code of said page. In said step 501, calculation of pixel values corresponding to said HTML objects is, for instance, performed as if an HTML page was shown in its original layout with 100% zoom factor. As a result, a maximum height and a maximum width in pixels of a number of rendered HTML objects is obtained.

In a step 502, it is then checked if the product of said maximum height and said maximum width is larger than a pre-defined threshold, for instance 100,000 pixels. If this is the case, a rectangular area containing the HTML objects rendered in step 501 is formed in a step 503. Otherwise, the step 501 of rendering HTML elements is continued until the condition of step 502 is met.

It should be noted that the calculation of step 502 only has to be performed when an area grows vertically and/or horizontally.

In step 503 (and also in step 502), when forming an area (i.e. calculating the display area in pixels that the created area would take), table areas having no information content (no text, no images, no input fields or similar) may not be taken into account (i.e. may not be included into formed area). In other words, within tables, areas are formed according to information content in the order in which said information content appears in the HTML page source code (e.g. HTML, XHTML or similar source code).

In a step 504, it is then checked if a lower edge of said formed area would vertically cut an element that cannot be divided (for instance an <image>, or an <object>). If this is the case, forming a section according to step 503 is retried so that the last HTML element tried to be included at the last time in step 503 is not included anymore. This procedure is repeated until it leads to a lower edge of said area that does not cut any element. In addition to elements that cannot be cut, this procedure may also be applied to paragraphs (<p>, <div>) and forms (<form>) and small tables (<table>).

This step may be performance-optimized by iterating first in bigger steps, and then element by element when new area edges are almost found.

According to step 503, it may be advantageous to leave a small padding between area borders and content, so that area borders and content do not touch even if an area is focused.

In a step 505, it is checked whether said formed area would not have a straight top edge. If this is the case, the algorithm returns to step 503 and tries to form a new area with a straight top edge. For example, if the first element for an area is in the middle of a left table column, and the next element would be in the top of the right table column, the end of an area should be created before the element that would make the top edge not straight.

If this is not the case, opportunities for combining sections are checked in a step 506.

For instance, if the width of an area matches that of a previous area, if these two areas are horizontally similarly positioned, and if the number of pixels of a combined area obtained when these two areas are taken together is less than a threshold, for instance 150,000 pixels, then these two areas are combined.

Furthermore, if forming areas would create empty space below areas, this empty space is combined with one or more areas above it, by vertically extending an area above it by a required amount. In this special case, the empty space is not taken into account when checking a condition for re-sectioning in a step 507, as will be explained below.

If this procedure of vertically extending areas to avoid empty spaces still leaves empty space between areas, vertical borders of areas are horizontally moved, so that empty space disappears (i.e. becomes included into areas). In this special case, too, empty space is not taken into account when checking a condition for re-sectioning in a step 507.

Finally, in a step 507, it is checked if re-sectioning of said formed area is necessary, wherein in said re-sectioning, the step 503 is again performed to form a new rectangular area.

For instance, if the number of pixels of a formed area gets bigger than a threshold, for instance 300,000 pixels, after its creation (for example because of a script adding content or arrival of big images), re-sectioning is done for that area and areas after it.

Similarly, if all content of a formed area disappears after its creation (because of a script or external CSS), re-sectioning is done for that area and areas after it.

As a result of the algorithm of FIG. 5, a plurality of areas is output. These areas then can be checked to contain said page element, as already explained with reference to step 401 of the flowchart of FIG. 4.

The exemplary flowchart for an algorithm for dividing an HTML page into areas according to FIG. 5 may be further refined by the following features:

If an absolute size of an image is set in an HTML source code, placeholders of that size may be rendered instead of said image in said step 501. If a size is not set (nor has been received yet with an image file), in said step 501 said image may be assumed to be of fixed size, for instance 50 pixels high and 100 pixels wide.

If a script writes a sequence of elements to an HTML page, that whole sequence added by a script is kept inside the same area.

If a script moves focus to another area than the currently active one, the area to which the focus moved is zoomed, and the previously zoomed area is shrunk.

If the number of pixels of an HTML element that cannot be divided into smaller pieces (for instance an <img> or <object>) is larger than a threshold, for instance 300,000 pixels, an own area may always be created for that element. The height of that area would be the height of the element, the left edge would be next to an area on the left (or edge of canvas if there is not an area on the left), and the right edge would be next to an area on the right (or edge of canvas if there is not an area on the right). In addition to HTML elements that cannot be divided, this rule may also be applied to big paragraphs (<p>, <div>) and big forms (<form>).

If an HTML element is hidden (using CSS), but if it is still set to reserve corresponding space for itself (using CSS), in said step 603 of forming rectangular areas it is handled as if it was visible (i.e. it is taken into account when calculating said area).

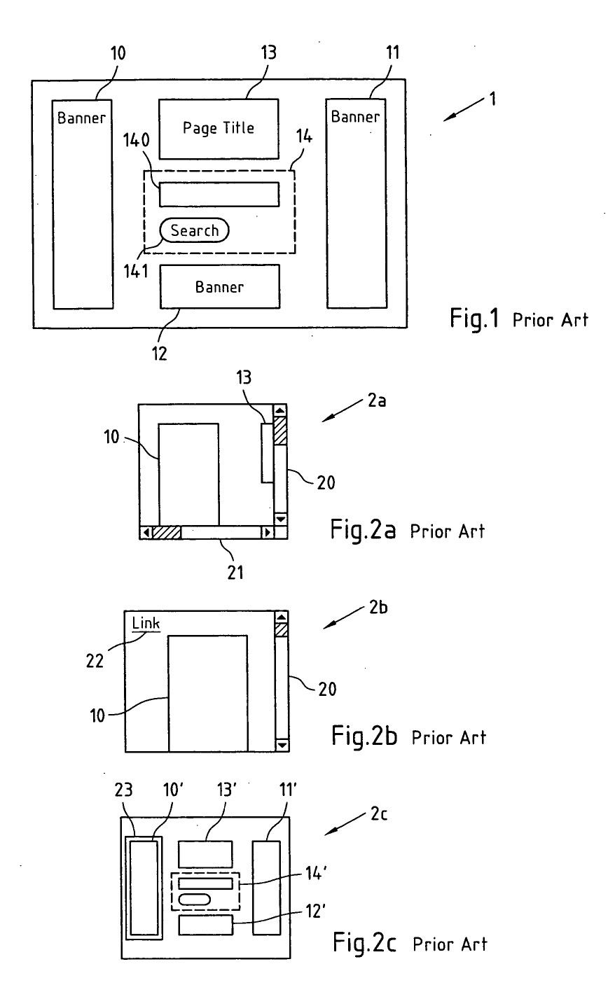

FIGS. 6a-6c illustrate the displaying of different representations 6a, 6b and 6c of said web page 1 of FIG. 1 on a small display of a hand-held device, respectively, wherein said representations 6a, 6b and 6c correspond to the three approaches a), b) and c) on how to display a large web page on a small display, respectively (cf. the introductory part of this patent specification). In contrast to the representations 2a, 2b and 2c of FIGS. 2a-2c, knowledge on the main content area 14 of the web page 1 as determined by the method of the present invention is now exploited to reduce the number of user operations that is required to explore said main content of said web page 1 when said web page is initially displayed.

FIG. 6a depicts a original layout representation 6a of the web page 1 on the small display, wherein the web page has been automatically scrolled in both horizontal and vertical direction to move the main content area 14 into the visible portion of the small display, for instance by displaying said mean content area 14 in the middle of the display, as depicted in FIG. 6a, or by aligning said main content area to the corners or borders of the small display. The user then can instantly, and without further navigation, explore the main content area 14.

FIG. 6b depicts a rendered representation 6b of the web page 1, wherein the web page 1 has been rendered to fit the width of the small display, and wherein the rendered web page has been automatically scrolled vertically to move the main content area 14 into the visible portion of the small display, so that instant access of the user to the main content area 14 is possible.

FIG. 6c depicts a small representation 6c of the web page 1, which can be enlarged by selection of single areas with an accentuation frame 23. In contrast to FIG. 2c, where the accentuation frame 23 resides on area 10′, the accentuation frame 23 now has been automatically moved to the main content area 14′ to allow for quick selection by a user without requiring any further navigation of the accentuation frame. It is also possible that the main content area 14′ is automatically selected to cause it to be displayed in large representation.

The invention has been described above by means of preferred embodiments. It should be noted that there are alternative ways and variations which are obvious to a skilled person in the art and can be implemented without deviating from the scope and spirit of the appended claims. In particular, the present invention is not limited to determining the main content area of web pages only, it may equally well be deployed to determine main content area in any other type of pages that are to be displayed on a small display, as for instance text documents or presentation slides.

What is claimed is:

1. A method for determining a main content area of a page, said method comprising:
determining which area of said page contains a page element that is positioned substantially in the middle of said page with respect to a first direction, and is offset by a pre-defined distance from a border of said page with respect to a second direction that is substantially orthogonal to said first direction, and
defining said area that contains said page element to be said main content area.

2. The method according to claim 1, wherein said first direction is a horizontal direction, wherein said second direction is a vertical direction, and wherein said pre-defined distance is taken from a top border of said page.

3. The method according to claim 1, wherein said page element is a pixel, and wherein said pre-defined distance is measured in pixels.

4. The method according to claim 1, wherein said pre-defined distance is measured in percent with respect to a dimension of said page in said second direction.

5. The method according to claim 1, wherein said step of determining which area of said page contains a page element comprises:
dividing said page into a plurality of areas by means of a sectioning algorithm.

6. The method according to claim 1, wherein a representation of said page is displayed.

7. The method according to claim 6, wherein in said displayed representation of said page, a representation of said main content area is automatically focused.

8. The method according to claim 7, wherein said representation of said main content area is focused by moving said representation of said main content area to a center of a display.

9. The method according to claim 7, wherein said representation of said main content area is focused by aligning at least one border of said representation of said main content area with at least one border of a display, respectively.

10. The method according to claim 6, wherein in said displayed representation of said page, a representation of said main content area is automatically emphasized.

11. The method according to claim 10, wherein said representation of said main content area is emphasized by displaying it in an enlarged representation.

12. The method according to claim 6, wherein when displaying said representation of said page, a reference is provided to a representation of said main content area.

13. The method according to claim 6, wherein said displayed representation of said page is an original layout representation of said page.

14. The method according to claim 6, wherein said displayed representation of said page is a representation in which said page is rendered to at least partially fit at least one dimension of a display.

15. The method according to claim 6, wherein said displayed representation of said page is a representation in which a plurality of areas, into which said page has been divided, is displayed in a small representation, and in which upon selection of one of said areas displayed in small representation, at least said selected area is displayed in a large representation.

16. The method according to claim 6, wherein said representation of said page is displayed on a display of a hand-held multi-media device.

17. A computer program with instructions operable to cause a processor to perform the method steps of claim 1.

18. A computer program product comprising a computer program with instructions operable to cause a processor to perform the method steps of claim 1.

19. A device for determining a main content area of a page, comprising:
means arranged for determining which area of said page contains a page element that is positioned substantially in the middle of said page with respect to a first direction, and is offset by a pre-defined distance from a border of said page with respect to a second direction that is orthogonal to said first direction, and
means arranged for defining said area that contains said page element to be said main content area.

20. A system for determining a main content area of a page, comprising:
means arranged for determining which area of said page contains a page element that is positioned substantially in the middle of said page with respect to a first direction, and is offset by a pre-defined distance from a border of said page with respect to a second direction that is orthogonal to said first direction, and
means arranged for defining said area that contains said page element to be said main content area.
